(19) United States
(12) Patent Application Publication
(10) Pub. No.: US 2014/0300485 A1
(43) Pub. Date: Oct. 9, 2014

(54) Method of non-intrusive communication of down hole annulus information

(71) Applicant: Benton Frederick Baugh, Houston, TX (US)

(72) Inventor: Benton Frederick Baugh, Houston, TX (US)

(21) Appl. No.: 13/856,438

(22) Filed: Apr. 4, 2013

(51) Int. Cl. E21B 17/00; G01V 11/00

(52) U.S. Cl. CPC E21B 17/003; G01V 11/002
USPC 340/855.1

(57) ABSTRACT

The method of non-intrusively collecting down hole information by providing one or more information collection devices in the annular area outside one or more casing strings and inside the drilled hole the one or more casing strings are suspended within, supporting the one or more casing strings in one or more hangers within a wellhead, providing one or more devices which transmit information outside the one or more casing strings and proximate the one or more hangers, providing one or more wirings between the one or more information collection devices and the one or more devices which transmit information, providing a one or more devices which receive information outside the wellhead to receive information transmitted by the one or more devices which transmit information, and making the wellhead of a non-magnetic material to allow the passage of the transmitted information.

### TECHNICAL FIELD

This invention relates to the method of non-intrusive communication of information regarding down hole annulus information to the surface.

### CROSS-REFERENCE TO RELATED APPLICATIONS

Not applicable.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

The quality of operations in the annulus outside a casing string and within the drilled hole has been purely a matter of speculation as the area is hostile and inaccessible. Of particular interest is the quality of the cement job. The importance of the quality of the cement job was emphasized in the 2010 blowout of the Macondo well in deepwater Gulf of Mexico.

The best solution to date has been to lower instrumentation into the well bore and attempt to determine the quality of the cement and bonding of the cement to the outside diameter of the casing through the wall of the steel tubing. This is not only a critical path time consuming operation, but must be removed before production can be started. Valuable information regarding the change of well conditions during the lifetime of the well is simply not available.

The developments of improved measurements made directly in the annuli have been hindered as there has been no reasonable way deliver the information to the surface. As the delivery of information implies an electric signal, the signal must be transmitted up the annulus to the casing support equipment at the surface, past the equipment and out to the environment for access by the personnel. The industry simply has not been able to develop ways of getting electric signals through and past the casing support equipment in remote operations such as are in subsea drilling.

An indication of the desire to achieve this type information communication has been indicated by the resources which have been expended to gain some of this information in subsea completion systems. The work in this area has involved special tubing hangers with special orientation and electrical stabs in an intrusive manner. This is theoretically possible in subsea drilling systems, but would involve major changes to the design of the equipment. The changes are so major that it simply will not be accomplished.

The long standing need to access information regarding down hole conditions outside the casing string has been demonstrated by efforts to gather this information from within the well bore through casing walls. However, no satisfactory solutions have been developed prior to this invention which literally allows the instrument to be directly in the environment outside the casing string, and then getting the information back to the operator.

### BRIEF SUMMARY OF THE INVENTION

The object of this invention is to provide a method of communication of information from a casing annulus to outside of the support housing without penetrating the housing.

A second object of this invention is to provide a method of reliably communicating the information up and along the casing annulus.

A third objective of this invention is to maintain the ability to have well control at all times by making the majority of the length along the outside of the casing of a profile which can be sealed upon by a blowout preventer.

### BRIEF DESCRIPTION OF THE DRAWINGS

FIG. 1 is a view of a deepwater drilling system which might use the features of this invention

FIG. 2 is a half section of a wellhead system and BOP Stack connector showing the method of this invention.

FIG. 3 is a cross section of two strings of casing of FIG. 2 taken along lines “3-3”.

FIG. 4 is an expanded portion of FIG. 3.

FIG. 5 is a half section of the wellhead similar to FIG. 2 showing a remotely operated vehicle (ROV) in a position to access the information regarding the down hole conditions.

### DETAILED DESCRIPTION OF THE INVENTION

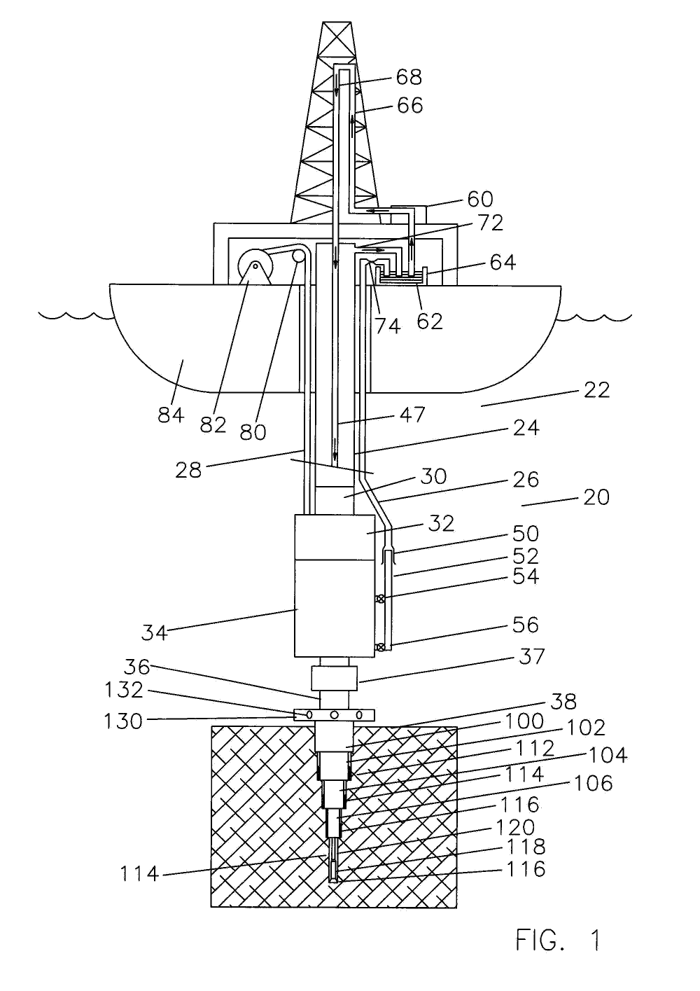

Referring now to FIG. 1, a view of a complete system for drilling subsea wells 20 is shown in order to illustrate the utility of the present invention. The drilling riser 22 is shown with a central pipe 24, outside fluid lines 26, and control lines 28.

Below the drilling riser 22 is a flex joint 30, lower marine riser package 32, lower blowout preventer stack 34 and wellhead system 36 landed on the seafloor 38.

The lower Blowout Preventer stack 34 generally comprises a lower hydraulic connector 37 for connecting to the wellhead system 36, usually 4 or 5 ram style Blowout Preventers, an annular preventer, and an upper mandrel for connection by the connector on the lower marine riser package 32.

Below outside fluid line 26 is a choke and kill (C&K) connector 50 and a pipe 52 which is generally illustrative of a choke or kill line. Pipe 52 goes down to valves 54 and 56 which provide flow to or from the central bore of the blowout preventer stack as may be appropriate from time to time. Typically a kill line will enter the bore of the Blowout Preventers below the lowest ram and has the general function of pumping heavy fluid into the well to overburden the pressure in the bore or to “kill” the pressure. The general implication of this is that the heavier mud will not be circulated, but rather forced into the formations. A choke line will typically enter the well bore above the lowest ram and is generally intended to allow circulation to circulate heavier mud into the well to regain pressure control of the well.

Normal drilling circulation is the mud pumps 60 taking drilling mud 62 from tank 64. The drilling mud will be pumped up a standpipe 66 and down the upper end 68 of the drill pipe 47. It will be pumped down the drill pipe 47, out the drill bit 45, and return up the annular area 70 between the outside of the drill pipe 47 and the bore of the hole being drilled, up the bore of the casing 42, through the subsea wellhead system 36, the lower blowout preventer stack 34, the lower marine riser package 32, up the drilling riser 22, out a bell nipple 72 and back into the mud tank 64.

During situations in which an abnormally high pressure from the formation has entered the well bore, the thin walled central pipe 24 is typically not able to withstand the pressures involved. Rather than making the wall thickness of the relatively large bore central pipe 24 thick enough to withstand the pressure, the flow is diverted to a choke line 26. It is more economic to have a relatively thick wall in a small pipe to withstand the higher pressures than to have the proportionately thick wall in the larger riser central pipe 24.

When higher pressures are to be contained, one of the annular or ram Blowout Preventers are closed around the drill pipe and the flow coming up the annular area around the drill pipe is diverted out through choke valve 54 into the pipe 52. The flow passes up through C&K connector 50, up fluid line 26 which is attached to the outer diameter of the riser 24, through choking means illustrated at 74, and back into the mud tanks 64.

On the opposite side of the drilling riser 24 is shown a cable or hose 28 coming across a sheave 80 from a reel 82 on the vessel 84. The cable 28 is shown characteristically entering the top of the lower marine riser package 32. These cables typically carry hydraulic, electrical, multiplex electrical, or fiber optic signals. Typically there are at least two of these systems, which are characteristically painted yellow and blue. As the cables or hoses 28 enter the top of the lower marine riser package 32, they typically enter the top of the control pod to deliver their supply or signals. When hydraulic supply is delivered, a series of accumulators are located on the lower marine riser package 32 or the lower Blowout Preventer stack 34 to store hydraulic fluid under pressure until needed.

Below the wellhead 36, a first casing string 100 is jetted into place and second, third, and fourth casing strings 102, 104 and 42 are hung as the well is drilled deeper and cemented in place. It can be seen that a hole was drilled for the second, third, and fourth casing strings, that the strings were landed and cemented in place. The cement is shown at 112, 114, and 116 respectively.

A hole is being drilled through the fourth casing string by drill string 47 which includes drill bit 45, heavy weight drill collars 118, and lighter weight drill pipe 120.

Guide base 130 surrounds wellhead system 36 and is shown with a set of docking holes 132 around the perimeter. These hoses will be suitable for the orientation and docking of an ROV (remotely operated vehicle) as a part of one option for recovering down hole information.

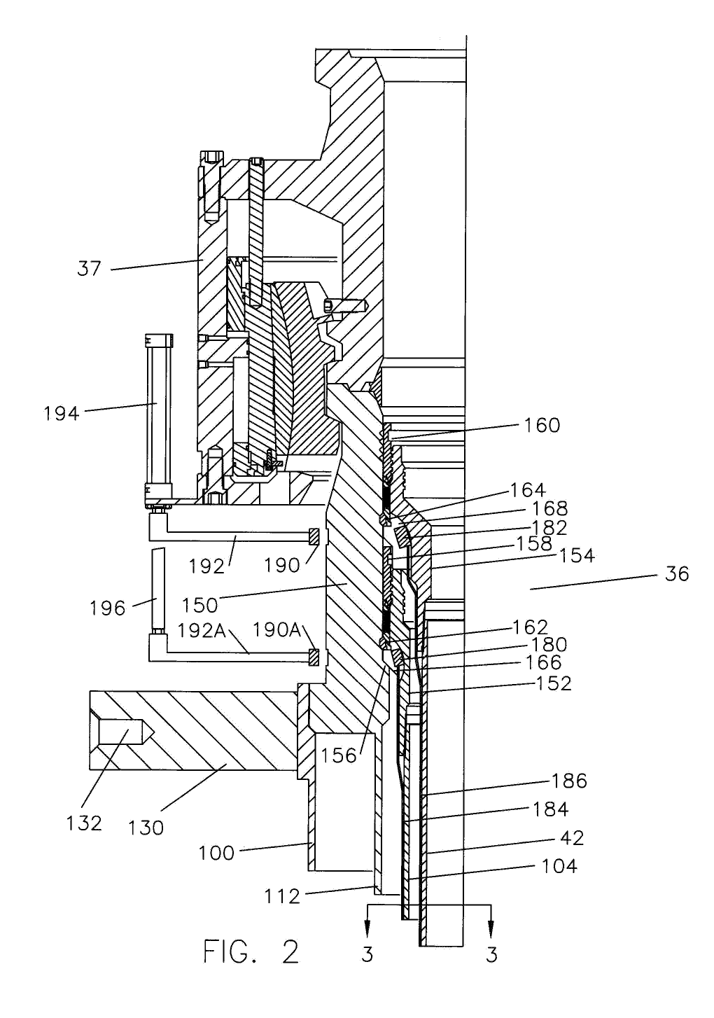

Referring now to FIG. 2, hydraulic connector 37 is shown connected to wellhead housing 150 of wellhead system 36. Hydraulic connector 37 is a hydraulic lock and hydraulic unlock connector which is described in detail in U.S. Pat. No. 6,609,734. Wellhead system 36 comprises wellhead housing 150 having casing hangers 152 and 154 suspended within on shoulder 156. Seal assemblies 158 and 160 are provided for casing hangers 152 and 154 respectively. Lockdown rings 162 and 164 are provided for casing hangers 152 and 154 respectively. Slots 166 and 168 are representative of one of several slots around casing hangers 152 and 154 respectively which allow circulation past the casing hangers during the cementing process. Casing hangers will characteristically have 8-12 slots around their perimeter.

Casing strings 170 and 172 are suspended from casing hangers 152 and 154 respectively. Transmitters 180 and 182 are inserted in one of the circulation slots of casing hangers 152 and 154 respectively and are connected to wires 184 and 186 respectively. Wires 184 and 186 are connected to appropriate sensing equipment down in the well. The most likely thing to be sensing in this way will be the quality of the cementing job after landing the respective casing string, however, other applications will include pressure, temperature, and chemical sensing.

Horizontally positioned from transmitters 182 is receiver 190 which is suspended on bracket 192 which is in turn suspended by cylinder 194 which is suspended from hydraulic connector 37. Cylinder 194 is shown in the retracted position. In this position, a signal can be transmitted from the transmitter 182 to the receiver 190, if the wellhead housing 150 is manufactured of a non-magnetic material such as 17-4 HH1150 stainless steel. If the wellhead housing 150 is made of alloy steels of conventional construction, the transmission of information will be blocked as would occur in conventional drill collars.

When the rod 196 of cylinder 194 is extended the receiver 190 and bracket 192 are moved downwardly as are indicated by 190A and 192A. and the receiver will receive information from transmitter 180 rather than transmitter 182. Alternately, this information from more than one transmitter can be collected by providing multiple receivers to match the multiple transmitters.

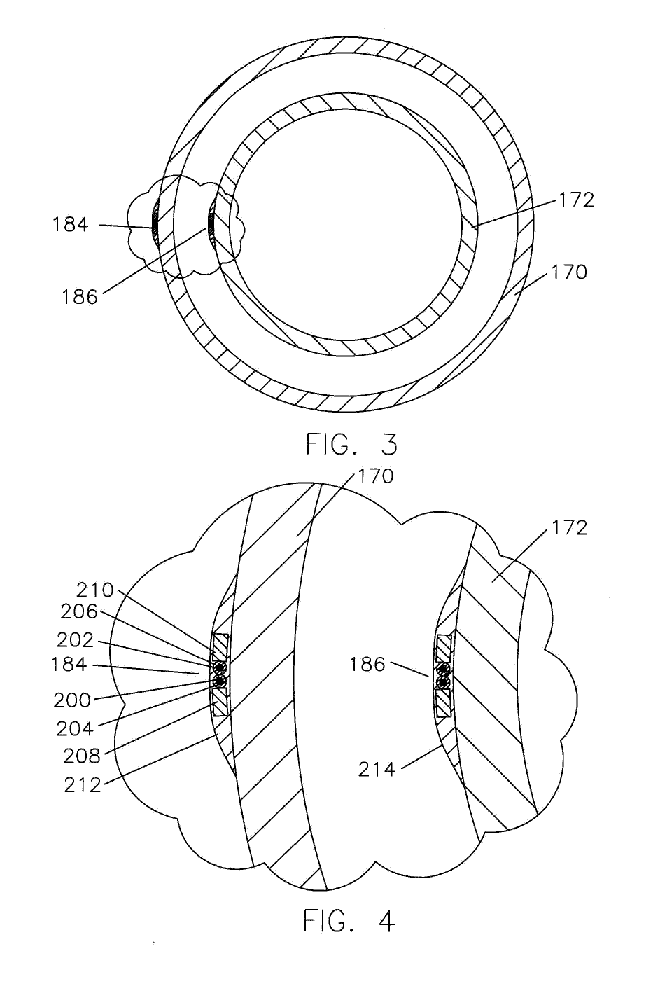

Referring now to FIG. 3, casing strings 170 and 172 are shown with wires 184 and 186. It can be noted that these wires are subjected to both substantial mechanical damage and the need to be sealed upon by blowout prevention equipment in unstable situations which may occur as the casing is being lowered into the well.

Referring now to FIG. 4, and enlarged portion of FIG. 3 is shown. wires 184 is shown as two wires 200 and 202 having insulation covers 204 and 206 around each respectively. Protective strips 208 and 210 are shown on each side of the wires. These strips are of a greater radial thickness than the wires 200 and 202 plus the insulation 204 and 206. In this case if physical damage were to be threatened to the soft copper wires, the relatively large cross section steel strips would protect the wires. Encapsulation 212 is provided around the wires and protective strips to give them a smooth profile and to taper off to each end. This encapsulation will allow conventional blowout preventers to seal across the wires in case of an unstable pressure situation within the well bore.

The wires at 186 are within a similar encapsulation 214, which can actually be identical to encapsulation 212 in spite of a difference in the diameter of the casing strings.

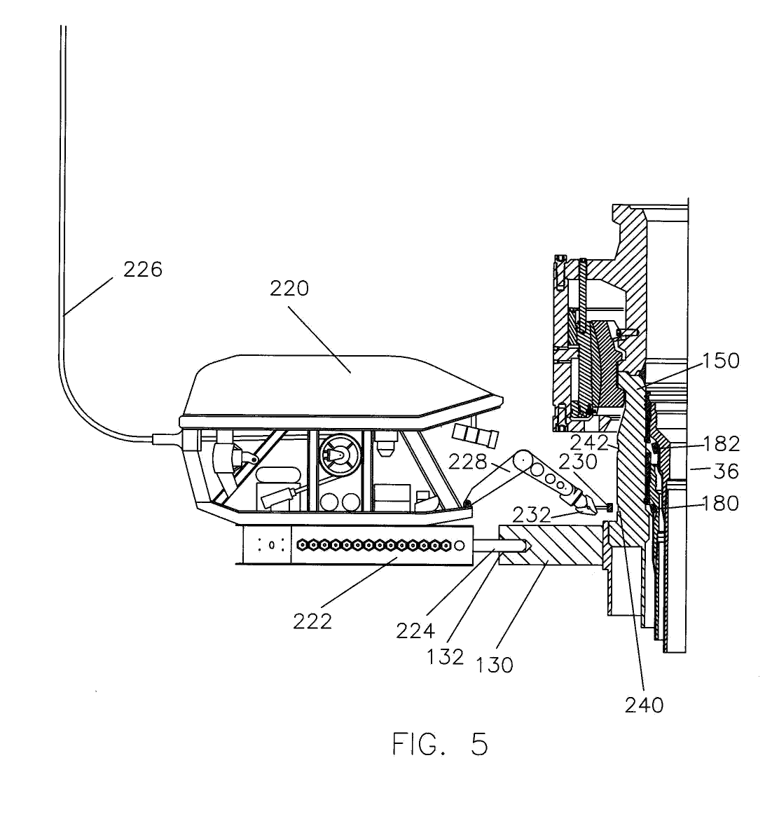

Referring now to FIG. 5, ROV (remotely operated vehicle) 220 is shown with a belly skid 222 having a docking pin 224 at the front which is engaged with docking holes 132 of guide base 130. Umbilical or tether 226 can carry the signals back to the surface in the case of a tethered vehicle, or would not exist in the case of an autonomous vehicle. The autonomous vehicle would come to the wellhead system, collect the information, record it, and return to the surface for downloading.

ROV manipulator arm 228 holds a transmitting and receiving device 230 in its gripper 232. As the internal transmitters 180 and 182 are of an unknown orientation when landed the ROV will need to land at one or more of the docking holes 132 to locate the signals from the transmitter. Groove 240 and 242 or other identifying marks are put into the wellhead housing 150 to identify the vertical elevation of the transmitters 180 and 182 respectively to assist in this process. Once the orientation is identified, it will be recorded simplifying the acquisition of information in subsequent situations.

The foregoing description has been to communicate information from the bottom of the well to the surface, however, the same technology can be utilized to send information from the surface down to the bottom of the well. Uses of this can be a variety of tasks from sending instructions to the information collection devices to collect or send information to operating down hole valves. It would even be practical to initiate a down hole operations sequence such as perforating a new pay one in a well.

A further use of this communication could be to communicate power to charge down hole batteries.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

That which is claimed is:

1. The method of non-intrusively collecting down hole information, comprising
providing one or more information collection devices in the annular area outside one or more casing strings and inside the drilled hole the one or more casing strings is suspended within,
supporting said one or more casing strings in one or more hangers within a wellhead,
providing one or more devices which transmit information outside said one or more casing strings and proximate said one or more hangers,
providing one or more wirings between said one or more information collection devices and said one or more devices which transmit information,
providing a one or more devices which receive information outside said wellhead to receive information transmitted by said one or more devices which transmit information, and
making said wellhead of a non-magnetic material to allow the passage of said transmitted information.

2. The method of claim 1 further comprising the position of said one or more of said devices which receive information can be adjusted vertically to receive the information from more than one devices which transmit information.

3. The method of claim 1 further comprising said one or more devices which transmit information can also receive information and said one or more devices which receive information can also transmit information.

4. The method of claim 1 further comprising
providing a battery within said device which can receive information,
said one or more devices which receive information can also transmit power and said one or more devices which transmit information can also receive power and
said power is utilized to charge said battery.

5. The method of claim 1 further comprising
providing a battery within said one or more information collection devices,
said one or more devices which receive information can also transmit power and said one or more devices which transmit information can also receive power and
said power is utilized to charge said battery.

6. The method of claim 1 further comprising said one or more casing hangers are also made of non-magnetic material.

7. The method of claim 6 further comprising the upper section of casing is also made of non-magnetic material.

8. The method of non-intrusively collecting down hole information, comprising
providing information collection equipment in the annular area outside a casing string and inside the drilled hole the casing string is suspended within,
supporting said casing in a hanger within a wellhead,
providing a transmitter outside said casing and proximate said hanger,
providing wiring between said information collection equipment and said transmitter,
providing a receiver outside said wellhead to receive information transmitted by said transmitter,
making said wellhead of a non-magnetic material to allow the passage of said transmitted information, and
providing an encapsulation around said wiring which can be sealed upon by a blowout preventer,

9. The method of claim 8 further comprising providing strips within said encapsulation to prevent said wires from being crushed.

10. The method of claim 8 further comprising providing said strips are made of metal.

11. The method of claim 8 further comprising providing said strips are made of metal which is non-magnetic.

12. The method of claim 8 further comprising said one or more casing hangers are also made of non-magnetic material.

13. The method of claim 12 further comprising the upper section of casing is also made of non-magnetic material.

14. The method of non-intrusively collecting down hole information, comprising
providing one or more information collection devices in the annular area outside one or more casing strings and inside the drilled hole the one or more casing strings is suspended within,
supporting said one or more casing strings in one or more hangers within a wellhead,
providing one or more devices proximate said one or more hangers which transmit and receive information,
providing one or more wirings between said one or more information collection devices and said one or more devices which transmit information,
providing a one or more devices outside said wellhead which transmit and receive information receive information transmitted and receive information to or from said one or more devices proximate said one or more casing hanger, and
making said wellhead of a non-magnetic material to allow the passage of said transmitted information.

15. The method of claim 14 further comprising said one or more devices outside said wellhead is mounted on equipment above said wellhead.

16. The method of claim 15 further comprising said one or more devices outside said wellhead is mounted on equipment above said is vertically adjustable to receive the information from more than one of said devices proximate said casing hanger.

17. The method of claim 14 further comprising said one or more devices outside said wellhead is mounted on a remotely operated vehicle.

18. The method of claim 17 further comprising said remotely operated vehicle docks with one or more docking ports on said guide structure.

19. The method of claim 14 further comprising said one or more devices outside said wellhead is mounted on an autonomously operated vehicle.

20. The method of claim 19 further comprising said autonomously operated vehicle docks with one or more docking ports on said guide structure.
